(19) United States
(12) Patent Application Publication
(10) Pub. No.: US 2009/0266249 A1
(43) Pub. Date: Oct. 29, 2009

(54) Intaglio Plate Wiping System

(75) Inventor: Paul Micallef, Marasaskala (MT)

Correspondence Address: OLIFF & BERRIDGE, PLC, P.O. BOX 320850, ALEXANDRIA, VA, 22320-4850, US

(73) Assignee: DE LA RUE INTERNATIONAL LIMITED, Basingstoke (GB)

(21) Appl. No.: 12/087,538

(22) PCT Filed: Jan. 30, 2007
(86) PCT No.: PCT/GB2007/000298

§ 371 Date: Jul. 23, 2008

(30) Foreign Application Priority Data
Jan. 30, 2006 (GB) 0601855.0

(51) Int. Cl. B41F 9/10

(52) U.S. Cl. 101/169

(57) ABSTRACT

An intaglio plate wiping system includes a wiping member which forms a nip with the intaglio plate in use and onto which excess intaglio ink is transferred during relative movement between the wiping member and the intaglio plate. A heated doctor blade unit is located downstream of the nip and cooperates with the wiping member to remove intaglio ink from the wiping member. A heated ink collecting container is provided into which ink removed from the wiping member passes.

The current invention is concerned with an improved wiping system for an intaglio printing press suitable for the printing of banknotes and other security documents.

Security documents are and have been printed for many years by the intaglio printing process. The term “intaglio printing”, as a general term, comprises the use of printing ink carrying surfaces, typically printing cylinders or printing plates, where the pattern to be printed is engraved and the engravings are filled with printing ink to be transferred to the printing substrate in order to create the document. Within this application “intaglio printing” is used to refer to the engraved steel die printing process where chromium plated, engraved steel or nickel plates or cylinders are used, and shall not include the rotogravure or gravure printing process. The term “plate” will be used to refer generally to any intaglio printing ink carrying surface.

Furthermore this invention does not relate to low viscous printing inks for the conventional gravure printing where a totally different concept of ink formulation is necessary. It is rather related to printing inks in paste form for engraved steel die printing.

In intaglio printing, the engraved printing plates are supplied with ink by one or more template inking cylinders by which a pattern of inks of different colour is transferred to the printing plates. The printing plates are then wiped by rubbing with a wiping cylinder which rotates in the opposite direction as the plate cylinder and which removes the excess ink found outside the intaglio cuts of the plate.

The plate with only ink present within the engraved regions is then used to print onto a substrate. The printing pattern in the engravings of the printing plate is transferred, under a pressure up to about 500 bars, on the substrate to be printed, which may be paper or plastic material in sheet or web form.

The current invention is particularly concerned with the wiping process, which cleans inks off of the surface of the intaglio plates but leaves ink present in the engravings. Specifically this invention is concerned with recovering ink wiped off of the intaglio plate by the wiping cylinder.

The wiping cylinder is usually situated in a wiping tank while a combination of nozzles squirting fresh wiping solution, brushes and doctor blade units is used to clean the wiping cylinder. The ink cleaned off the wiping cylinder is then treated through an effluent processing system and disposed off as waste.

It is widely recognised that the intaglio printing process, though highly secure, is both expensive and wasteful with respect to ink usage. It is estimated that anything up to 66% of the ink used in intaglio printing is wasted and ends as waste via the effluent treatment process. This is both a waste of ink and not very environmentally friendly. It has been recognised that a process that allows for ink to be recovered from the wiping cylinder in a form suitable for reuse would allow for both a significant cost saving and a distinct environmental benefit.

In accordance with the present invention, an intaglio plate wiping system comprises a wiping member which forms a nip with the intaglio plate in use and onto which excess intaglio ink is transferred during relative movement between the wiping member and the intaglio plate;

a doctor blade unit downstream of the nip and cooperating with the wiping member to remove intaglio ink from the wiping member;

a system for heating the doctor blade unit;

an ink collecting container into which ink removed from the wiping member passes; and

a system for heating the ink collecting container.

The inventor has recognised that it is possible to recover excess intaglio ink but it is important to ensure that the ink does not cure prior to being collected. This problem is solved therefore by providing a system for heating the doctor blade unit and a system for heating the ink collecting container. The ink thus remains in an uncured form until it can be stored in a further storage container.

In a preferred method, a mechanical ink agitator is used to prevent ink building up on the doctor blade unit. Ink building up on the doctor blade may cure generating a hard uneven surface on the doctor blade. This prevents ink being transferred off the doctor blade and reduces the efficiency of the doctor blade at removing ink from the wiping member, which ultimately results in ink building up and setting on the wiping member.

In an alternative to a mechanical agitator, ink build up on the wiping member and the doctor blade unit can be prevented by the use of a solvent supply system for supplying solvent to the wiping member in a region between the nip and the doctor blade unit. The solvent supply system could comprise one or more spray nozzles but preferably comprises a wetting roller engaging the wiping member for transferring a film of solvent onto the wiping member. A wetting roller has the advantage that not only does it transfer solvent onto the wiping member but also agitates ink on the wiping member to promote dissolution of the ink. This can be further promoted by providing a non-smooth surface to the wetting roller, for example using an arrangement of grooves or other protrusions.

The ink collecting container could have a sloped base such that collected ink flows towards an outlet but alternatively a transfer system could be provided within the ink collecting container such as a rotatably mounted auger or other transfer mechanism.

In addition, the system preferably further comprises a transfer system coupled to the ink collecting container for transferring collected ink to a storage container, the transfer system including a heated conduit. Again, by maintaining the conduit heated, the ink does not cure and so can be transferred conveniently to the storage container. This transfer can be achieved under gravity or preferably by use of an auger or other transfer mechanism.

Some examples of an intaglio plate wiping system according to the present invention will now be described and contrasted with a prior art system with reference to the accompanying drawings, in which:

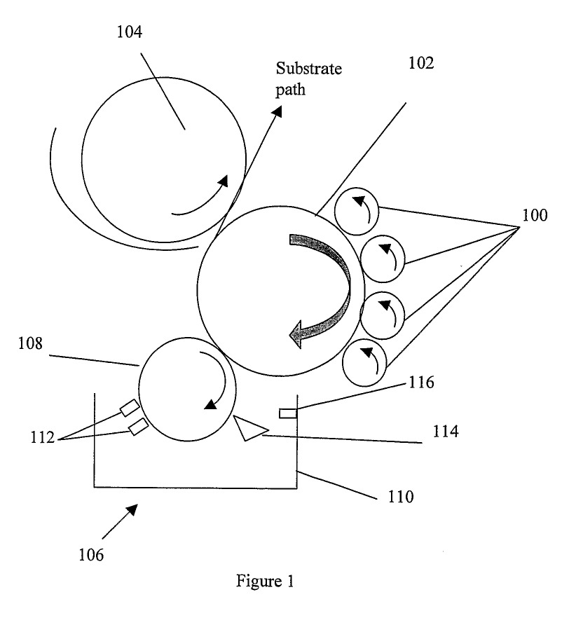

FIG. 1 is a schematic view of a conventional intaglio printing press including a wiping system;

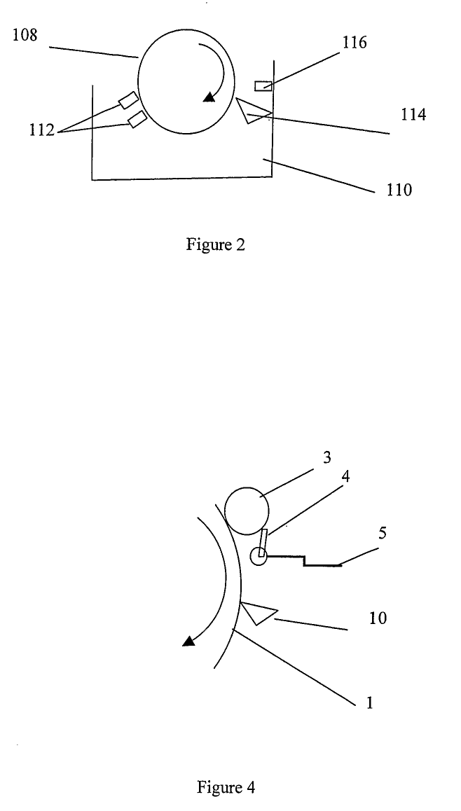

FIG. 2 illustrates the wiping system of FIG. 1 in more detail;

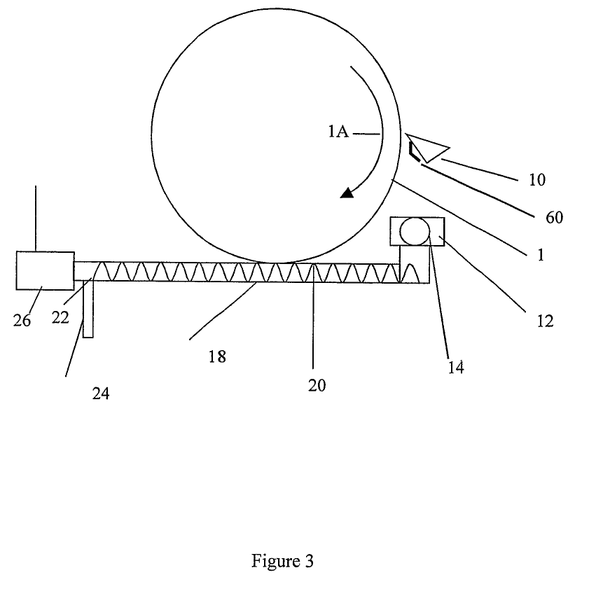

FIG. 3 illustrates part of a wiping system according to a first embodiment of the present invention;

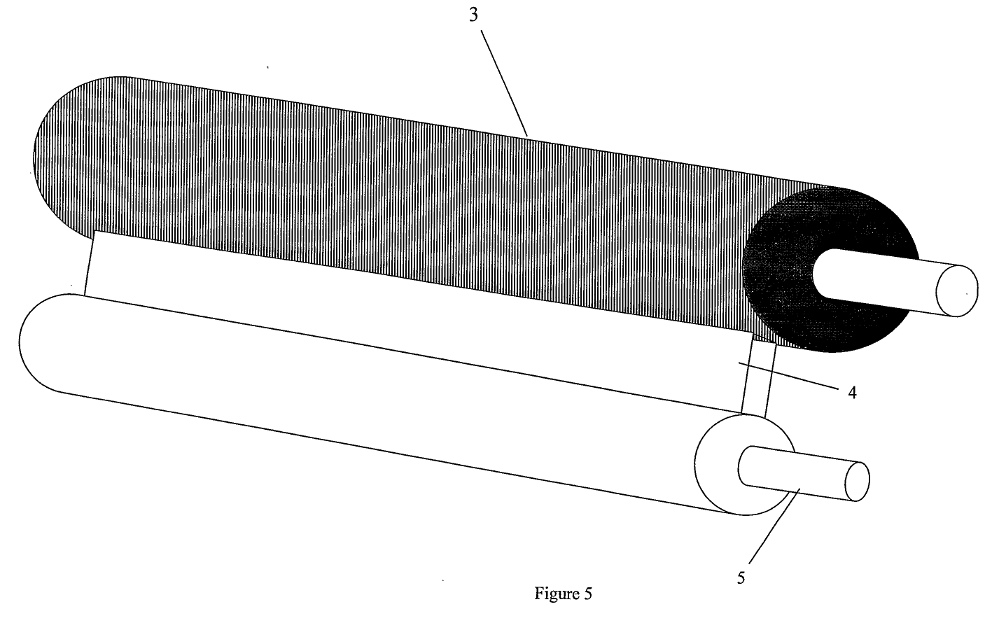

FIG. 4 illustrates part of a wiping system according to a second embodiment of the present invention;

FIG. 5 is a perspective view of a wetting roller and solvent wetting unit;

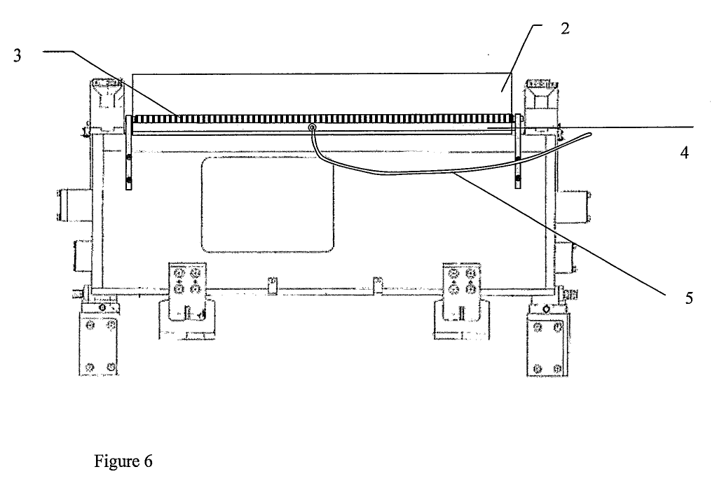

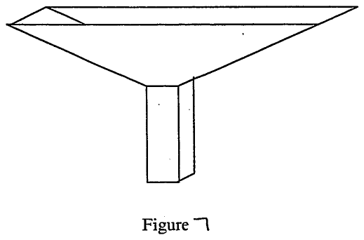

FIG. 6 illustrates the wiping system of FIG. 4 from the rear;

FIG. 7 illustrates a first example of an ink collection container;

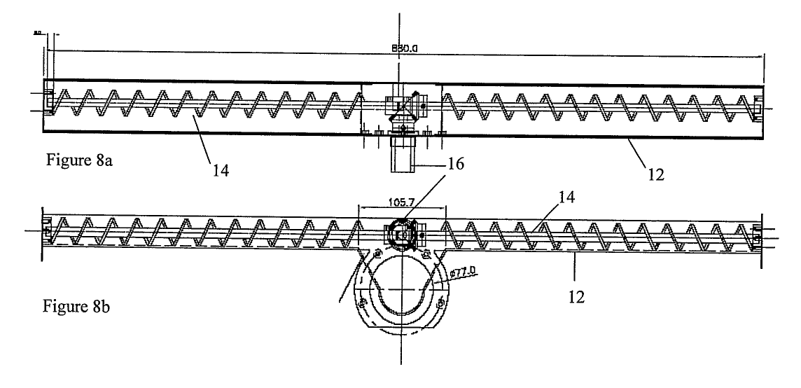

FIGS. 8a and 8b illustrate a second example of an ink collection container in plan and cross-section respectively; and

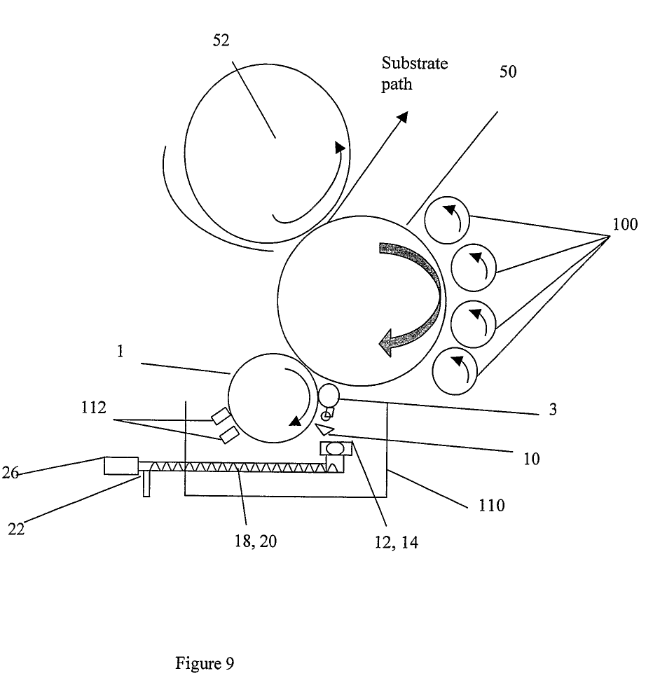

FIG. 9 illustrates an intaglio printing press incorporating the wiping system shown in FIG. 4.

FIG. 1 illustrates schematically the inking cylinders 100, printing plate 102, impression cylinder 104 and wiping unit 106 including a wiping cylinder 108 in a tank 110 and cooperating with brushes 112 and a doctor blade 114 and a washing solution jet 116 of a typical prior art intaglio printing press. The arrows indicate the direction of rotation of the various units. The intaglio printing plate 102 is inked all over by each of the inking cylinders 100. Each inking cylinder 100 transfers a different colour ink onto the printing plate 102. At this point the printing plate 102 is substantially covered all over by ink and the excess on the plate surface must be removed leaving ink only in the engraved regions of the plate. The wiping cylinder 108, which is pressed hard against the printing cylinder 102, cleans the printing plate surface and via a rubbing action removes the excess surface ink from the printing plate. The printing plate 102 then rotates to form a nip with the impression cylinder 104. The substrate is inserted in this nip between the printing cylinder and the impression cylinder and the ink is forced out of the engravings onto the substrate under very high pressures.

In order for the wiping cylinder 108 to efficiently remove the ink from the surface of the printing plate it must be cleaned each time after it has completed a wiping operation. FIG. 2 shows a schematic of the prior art wiping process in isolation for purposes of clarity. This process currently comprises two main steps. In a first step the doctor blade unit 114 is brought hard against the cylinder 108 and scrapes off excess ink. As the blade is in direct contact it is necessary to provide some lubrication with a wiping solution. Currently this wiping solution is sprayed out of apertures or nozzles 116 mounted on the back wall on the wiping tank just above the wiper doctor blade unit 114. The wiping solution comprises a mixture of hot water, detergent and sodium hydroxide. The wiping cylinder 108 then rotates round to a further series of nozzles (not shown). The first of these spray from the doctor blade unit spraying wiping solution and a second series of sprays are situated between a series of rows of brushes 112 (normally 4). The brushes further scrub the surface of the wiping cylinder 108 removing any ink not removed by the doctor blade unit 114. A second doctor blade unit (not shown) at the outer side of the wiping tank removes any solution and remaining traces of ink rendering the wiping cylinder sufficiently clean to undertake another wiping operation on the printing plate.

Examples of embodiments of wiping systems according to the current invention are shown in FIGS. 3 and 4 and in more detail in FIGS. 5, 6 and 8. Referring to FIG. 1, the wiping system comprises a wiping cylinder or roller 1 which rotates in the direction shown by an arrow 1A. Downstream of the nip between the printing cylinder and the wiping cylinder is mounted a heated doctor blade unit 10 which engages the surface of the wiping cylinder 1. In the preferred embodiment shown in FIG. 3, a mechanical agitator 60 is positioned such that it contacts and traverses along the heated doctor blade 10 facilitating the removal of ink from the doctor blade and preventing build up of dried ink.

Ink on the surface of the wiping cylinder 1 which has been removed by the doctor blade unit 10 drops into a collecting trough 12 and is transported by an auger 14 to a central downwardly opening aperture 16 (FIG. 8a) from where it drops down into a horizontally extending transfer pipe 18 in which is rotatably mounted a transfer pipe auger 20. Rotation of the auger 20 draws the ink along the pipe 18 to an outlet 22 from where the ink passes to a storage area 24.

The augers 14, 18 are driven via a common drive motor 26.

It has been recognised by the inventor that a large portion of ink present on the wiping cylinder could be recovered by providing a suitable receptacle under the doctor blade unit and then optionally transferring the ink from this receptacle to a suitable storage area. This has been achieved by providing a number of modifications to the wiping section of the press and results in a significant ink saving.

In this embodiment, the improved wiping section comprises three key modifications:
The provision of a mechanical agitator 60 to facilitate ink removal from the heated doctor blade unit 10.
The provision of an ink collecting area 12 immediately under the doctor blade unit 10.
A means 18,20 to transport ink from the collecting area 12 to the storage area or container 24.

In a second embodiment, illustrated in FIG. 4, the wiping system comprises a wetting cylinder or roller 3 provided against a surface of the wiping cylinder 1 and sits in a solvent container or trough 4 supplied via a solvent supply pipe 5 from a solvent source (not shown). Downstream of the wetting cylinder 3 in the direction of rotation of the wiping cylinder 1 is mounted a heated doctor blade unit 10 which engages the surface of the wiper cylinder 1.

Ink on the surface of the wiping cylinder 1 is then removed by the heated doctor blade unit 19 and drops into a collecting trough 12. The transport of the ink into storage area 24 is the same as for the embodiment shown in FIG. 3. The heated doctor blade unit 10 may comprise a mechanical agitator as detailed in the previous embodiment although this is not essential as the solvent from the solvent supply system reduces the likelihood of the ink drying and building up on the doctor blade.

In this embodiment, the improved wiping section comprises three key modifications:
The provision of a wetting roller 3 immediately prior to the doctor blade unit 10.
The provision of an ink collecting area 12 immediately under the doctor blade unit 10.
A means 18,20 to transport ink from the collecting area 12 to the storage area or container 24.

It will be appreciated from the earlier discussion that variations of these modifications are possible. For example, the wetting roller 3 could be replaced by a spray and the ink need not be transported to a further storage container but could remain in the collection trough.

The modifications in the two embodiments enable the ink to be collected and to be transported efficiently to the final storage area. It should be recognised that due to the special nature of intaglio printing inks neither of these tasks is routine. A detailed discussion of the necessary properties and example formulations of intaglio inks can be found in EP0340163 and will not be gone in to detail here. For the purposes of this document it is only necessary to appreciate that intaglio inks are typically heat set and have special rheology and rapid film forming capabilities. Heat set intaglio inks are designed to be printed at elevated temperatures in the region of 70 to 80° C. The raised temperatures serve two purposes, firstly the ink rheology changes at an elevated temperature so the inks becomes less viscous and flows freely into the engraved lines on the plate. At ambient room temperature the ink is very thick and hardly flows at all. Secondly the elevated temperature starts the curing process so the ink begins to cure almost immediate upon contact with the paper and as it begins to cool. Typically the ink will be touch dry almost immediately after being transferred to the paper. The actual body of the thick ink layer does not fully cure for several hours but a thin dry film is formed on the surface to allow the printed sheets to be stacked.

It was therefore essential to take the properties of the intaglio ink into consideration when redesigning the wiping tank to enable ink recovery. In order to recover the ink in a form such that it can be reused it is important that any recovered ink is maintained at an elevated temperature to ensure it retains its flow characteristic. It is also important to move the ink from the collecting area to the storage quickly and efficiently where a separate storage area is provided. Once the ink is in the storage area it can be allowed to cool down. In storage the ink will normally form a dry ink film on any surface exposed to air. This dry ink film protects the ink underneath from the air and the main body of ink doesn't set.

It has also been found that, in the conventional arrangement, ink removed using the doctor blade unit cools down on the doctor blade unit and begins to set. It was therefore necessary to provide an alternate configuration that allowed the doctor blade unit to be heated thus ensuring the ink removed from the wiping cylinder is held at an elevated temperature.

The most effective way of heating the doctor blade unit 10 is to seal the nozzle outlets (not shown) but still circulate hot water through the existing pipework. The doctor blade unit is then heated by conduction. Alternatively, a new doctor blade unit could be manufactured without the nozzles but with a network of pipes specifically designed to maintain the doctor blade unit at an elevated temperature.

An observed benefit of the first embodiment of the current invention is that the combination of the heated doctor blade unit and mechanical agitator results in it no longer being necessary to lubricate the wiping cylinder 1 in the region of the blade doctor unit.

If the doctor blade unit does not comprise a mechanical agitator then the lubrication of the wiping cylinder 1 in the region of the doctor blade unit 10 can be achieved by the use of a wetting roller 3 as described in the second embodiment of the current invention. In the prior art, this is achieved using a series of nozzles mounted on the inner wall of the wiping cylinder tank and a hot aqueous mixture of detergent and sodium hydroxide is squirted out of these nozzles. This prior art wiping solution destroys the essential characteristics of intaglio ink; therefore the spray bar applying this aqueous solution is removed and replaced with the wetting roller 3 that is applying a solvent that is non-detrimental to the intaglio ink. An example is a hydro carbon solvent such as a Sicpa No 859041 which lowers ink viscosity. Another example is PARASET26H supplied by PETROCHEM CARLESS LIMITED.

The wetting roller 3 comprises a finely grooved hard plastic roller, which is mounted at the edge of the wiping tank and contacts the wiping cylinder, this is illustrated in FIG. 4. The wetting roller 3 rotates with the wiping cylinder 1 and transfers a thin film of solvent to act as a lubricant on to the wiping cylinder. FIG. 5 illustrates in more detail the grooved plastic wetting roller 3 sat on the back wall of the wiping tank with the solvent solution inlet. This shows a grooved plastic roller but any hard wearing and suitably compliant material could be used for the wetting roller 3. Furthermore the grooved pattern has been selected on the basis of trials to rub in a small amount of solvent into the dried up ink on the surface of the wiping cylinder collected from the plate cylinder. In a typical example, the roller 3 has circumferential (vertical) grooves of 3 mm wide, 3 mm spaced and 3 mm in depth. An anilox roller could be used, indeed any patterning that transfers the correct amount of solvent to the wiping cylinder would be acceptable. FIG. 6 shows a view from the rear of the wiping cylinder showing the wetting roller in place.

Now that the wiping cylinder 1 is suitably lubricated and the doctor blade unit 10 heated the ink can be removed and then moved away from the wiping cylinder itself. However it is still necessary to collect the removed ink and transport it to a suitable storage area 24. One means to collect the ink would be a heated trough with a base suitably angled to allow the ink to move away under the force of gravity. Such an arrangement is illustrated in FIG. 7. However the preferred approach is to physically move the ink within the collecting area. This allows the ink to be transferred more rapidly from the collecting area to the means to transport the ink to the storage area.

FIGS. 8a and 8b show one approach developed for moving the ink within the collection area 12. Here a central ink-collecting channel is provided with a motorised auger 14. FIG. 8a shows a plan view of the collecting area as viewed from above. Within a trough the auger mechanism 14 is provided that rotates within the trough. As ink falls into the trough the auger rotates and moves the ink from the outer edges into the central collecting area. Within FIG. 8a the gearing mechanism for the auger is illustrated however in use this would be protected from the ink in a sealed area. FIG. 8b shows an alternative cross section view of the ink collecting area and auger mechanism. This illustration more clearly shows the central region where the ink, once transported by the augers, drops into a central collecting area 16. In order to ensure that the ink that has been collected and is being moved remains at an elevated temperature (at least above 35° C.) heating elements (not shown) are provided in the collecting trough. The heating elements may be electrical or can make use of the existing hot water supply in a similar manner to that for the doctor blade unit.

Once the ink has be transferred to the central collecting area it is then necessary to move the ink out of the wiping cylinder area and into a storage area or container. Again this could be achieved under the force of gravity but it is more preferable that it is done using a mechanical process to physically move the ink. One example of how this might be achieved is to use the auger 20 within the pipe 18 leading from the central collecting area to the storage area or container; this is illustrated in FIG. 3.

Ink from the collecting trough 14 drops from the central collecting point into the transfer pipe 18 containing the auger 20. The ink is then moved down the pipe to the outlet 22, at the outlet the ink is passed into a storage area or container 24. Again it is necessary to heat the transfer pipe to ensure the ink is maintained at an elevated temperature. As for the collecting trough this can be achieved using an electrical heating element or via a heated water mechanism (not shown).

In the mechanism described it is necessary to drive the augers 14,20. The two augers can be driven separately but it is more preferable if they are driven by the single drive mechanism 26. It has been found that by using a suitable gear mechanism the drive from the mechanism in the collecting trough can be shared with auger in the transfer pipe.

FIG. 9 illustrates schematically the ink recovery mechanism, as described with reference to the second embodiment shown in FIG. 4, in place on an intaglio printing machine having an intaglio plate 50 mounted on a printing cylinder and engaging an impression cylinder 52 and the wiping cylinder 1.

Once the ink has been collected and transferred to the storage area or container 24 it can be left to cool. The ink can then be stored until it is required for reuse. Alternatively even if the ink is not required for reuse it can be disposed off. The disposal of the ink still presents a significant environmental benefit as it means there is still considerably less ink in the effluent that has to be processed than in prior art systems.

1. An intaglio plate wiping system comprising a wiping member which forms a nip with the intaglio plate in use and onto which excess intaglio ink is transferred during relative movement between the wiping member and the intaglio plate;
a doctor blade unit downstream of the nip and cooperating with the wiping member to remove intaglio ink from the wiping member;
a system for heating the doctor blade unit;
an ink collecting container into which ink removed from the wiping member passes; and
a system for heating the ink collecting container.

2. A system according to claim 1, wherein the doctor blade unit heating system includes one or more heating pipes passing through or adjacent to the doctor blade unit for carrying a heated fluid.

3. A system according to claim 1, further comprising a mechanical agitator to facilitate ink removal from the doctor blade unit.

4. A system according to claim 1, further comprising a solvent supply system for supplying solvent to the wiping member in a region between the nip and the doctor blade unit.

5. A system according to claim 4, wherein the solvent supply system includes a wetting roller engaging the wiping member for transferring a film of solvent onto the wiping member.

6. A system according to claim 5, further comprising a solvent supply reservoir connected to supply solvent to the wetting roller.

7. A system according to claim 5, wherein the wetting roller is provided with an arrangement of grooves or an anilox.

8. A system according to claim 7, wherein the grooves extend substantially parallel with the axis of the wetting roller, or circumferentially.

9. A system according to claim 1, wherein the ink collecting container includes a system for transferring collected ink to an outlet of the container.

10. A system according to claim 9, wherein the transfer system comprises a rotatably mounted auger.

11. A system according to claim 1, further comprising a transfer system coupled to the ink collecting container for transferring collected ink to a storage container, the transfer system including a heated conduit.

12. A system according to claim 11, further comprising a rotatably mounted auger in the heated conduit.

13. A system according to claim 10, wherein the augers are driven from a common drive motor.

14. A system according to claim 1, wherein the wiping member comprises a rotatably mounted cylinder.

15. An intaglio printing system including an intaglio printing plate;
an inking system for transferring ink to the intaglio plate; and
an intaglio plate wiping system according to claim 1 for removing excess ink from the intaglio printing plate.
